(19) United States
(12) Patent Application Publication
(10) Pub. No.: US 2023/0398644 A1
(43) Pub. Date: Dec. 14, 2023

(54) FERRITIC STAINLESS STEEL WELDING WIRE AND WELDED PART

(71) Applicant: DAIDO STEEL CO., LTD., Nagoya-shi (JP)

(72) Inventors: Masato UCHI, Nagoya-shi (JP); Masakazu YAMASHITA, Nagoya-shi (JP); Akio UENAKA, Nagoya-shi (JP); Osamu HARA, Nagoya-shi (JP)

(21) Appl. No.: 18/206,489

(22) Filed: Jun. 6, 2023

(30) Foreign Application Priority Data
Jun. 10, 2022 (JP) 2022-094541
Feb. 21, 2023 (JP) 2023-025406

(51) Int. Cl. B23K 35/30; C21D 8/06; C22C 38/00; C22C 38/02; C22C 38/04; C22C 38/06; C22C 38/42; C22C 38/44; C22C 38/50; C22C 38/48

(52) U.S. Cl. CPC B23K 35/3086; C21D 8/065; C22C 38/001; C22C 38/002; C22C 38/02; C22C 38/04; C22C 38/06; C22C 38/42; C22C 38/44; C22C 38/50; C22C 38/48; C21D 2211/005

(57) ABSTRACT

The present invention relates to a ferritic stainless steel welding wire, including, in terms of mass %: C: ≤0.050%; Si: ≤1.00%; Mn: 2.50% to 5.00%; P: ≤0.040%; S: ≤0.010%; Cu: ≤0.50%; Ni: 0.01% to 1.00%; Cr: 12.0% to 20.0%; Mo: ≤0.50%; Ti: 0.20% to 2.00%; Nb: 0.10% to 0.80%; Al: 0.020% to 0.200%; Mg: ≤0.020%; O: ≤0.020%; and N: 0.001% to 0.050%, with the balance being Fe and unavoidable impurities, and having a Ni equivalent represented by Equation (1) of 1.0 to 3.0, Ni equivalent=[Ni]+0.5×[Mn]+30×[C]+30×([N]−0.06) Equation (1), in Equation (1), [X] represents a content (mass %) of an element X, and relates to a welded part.

### CROSS-REFERENCE TO RELATED APPLICATIONS

This application is based on and claims priority under 35 USC 119 from Japanese Patent Applications No. 2022-094541 filed on Jun. 10, 2022 and No. 2023-25406 filed on Feb. 21, 2023, the contents of which are incorporated herein by reference.

### TECHNICAL FIELD

This invention relates to a ferritic stainless steel welding wire and a welded part.

### BACKGROUND ART

A ferritic stainless steel is less expensive than an austenitic stainless steel and has a low thermal expansion coefficient, and therefore, thermal strain can be prevented. The ferritic stainless steel is also excellent in high-temperature oxidation resistance, so that it is widely used for automobile exhaust system parts, which are used in a high-temperature corrosive gas environment. Examples of the automobile exhaust system parts include an exhaust manifold for collecting exhaust gas from an engine and sending the exhaust gas to an exhaust pipe, and a case of a converter for purifying the exhaust gas using oxidation-reduction reaction in the presence of a catalyst. These parts having complicated shapes are assembled by welding members made of ferritic stainless steel. Generally, the welding of the members made of ferritic stainless steel uses a welding wire made of ferritic stainless steel having the same or similar composition with respect to the members.

It is known that a weld metal formed using a ferritic stainless steel welding wire tends to have coarse crystal grains and occur weld cracks. Even if the weld cracks can be avoided, cracks are likely to occur when a bending force is repeatedly applied to a weld metal portion. Therefore, for the ferritic stainless steel welding wire, it is desired to improve a corrosion resistance of the weld metal portion and refine a weld metal microstructure.

For refining the weld metal microstructure, there is a known technique of using a welding wire having an alloy composition capable of crystallizing nitrides of Ti, Al, and the like, dispersing these crystallized substances in a molten metal during welding, and using the molten metal as nuclei during ferrite formation (see, for example, Patent Literature 1). However, welding wires specifically disclosed in Examples of Patent Literature 1 are different from the present invention in that Mn contents thereof are all as low as less than 2.5% and that they do not satisfy Equation (1) of the present invention.
Patent Literature 1: JP2006-231404A

### SUMMARY OF INVENTION

Against the background of the circumstances described above, an object of the present invention is to provide a ferritic stainless steel welding wire and a welded part that are effective in refining a weld metal microstructure and preventing occurrence of cracks in a weld metal portion.

In order to solve the above technical problem, inventors of the present invention made keen examination and found that, by defining austenite forming elements such as Ni and Mn contained in the ferritic stainless steel welding wire within a predetermined range, phase transformation occurs in the process in which the molten metal is solidified and cooled to approximately room temperature, and by utilizing such phase transformation, refinement of the weld metal microstructure can be promoted. The present invention is made based on such finding.

Accordingly, a ferritic stainless steel welding wire according to a first aspect of the present invention is specified as follows. That is, the ferritic stainless steel welding wire includes, in terms of mass %, C: ≤0.050%; Si: ≤1.00%; Mn: 2.50% to 5.00%; P: ≤0.040%; S: 0.010%; Cu: ≤0.50%; Ni: 0.01% to 1.00%; Cr: 12.0% to 20.0%; Mo: ≤0.50%; Ti: 0.20% to 2.00%; Nb: 0.10% to 0.80%; Al: 0.020% to 0.200%; Mg: ≤0.020% (including zero); O: ≤0.020%; and N: 0.001% to 0.050%, with the balance being Fe and unavoidable impurities, and having a Ni equivalent represented by the following Equation (1) of 1.0 to 3.0.

Ni equivalent=[Ni]+0.5×[Mn]+30×[C]+30×([N]−0.06) Equation (1).

Here, [X] in the above Equation (1) represents a content (mass %) of an element [X] contained in the steel.

According to the welding wire of the first aspect specified in this way, by using crystallized substances such as TiN, and also using phase transformation, a microstructure of the weld metal can be refined.

Ordinary ferritic stainless steel hardly transforms in the process of cooling, but in the welding wire of the first aspect, each austenite forming element (Ni, Mn, C and N) and the Ni equivalent represented by Equation (1) are all specified within a predetermined range, so that in the process of the molten metal solidifying and cooling to approximately room temperature, a part of 6 ferrite phase is once transformed into austenite (δ/γ transformation) and further transformed into a ferrite (γ/α transformation), thereby refining the weld metal microstructure. Here, the welding wire of the first aspect includes a large amount of Mn in particular among the austenite forming elements.

According to the first aspect, in a second aspect of the present invention, a T value represented by the following Equation (2) may be 12.0 or more. According to the welding wire of the second aspect specified in this way, formation of a Cr-deficient layer is prevented, so that the microstructure of the weld metal can be refined and a corrosion resistance of the weld metal portion can also be improved.

T value=([Ti]+[Nb])/([C]+[N]) Equation (2)

Here, [X] in the above Equation (2) represents a content (mass %) of an element [X] contained in the steel.

A welded part according to a third aspect of the present invention is specified as follows. That is, the welded part includes a weld metal portion formed using the ferritic stainless steel welding wire according to the first aspect or the second aspect, in which the weld metal portion has a grain size number of 3 or more.

### BRIEF DESCRIPTION OF DRAWINGS

FIG. 1A and FIG. 1B are explanatory diagrams of grain size measurement and a corrosion resistance test;

FIG. 2 is an explanatory diagram of a cracking resistance test; and

FIG. 3A and FIG. 3B are explanatory diagrams of a bending test.

### DESCRIPTION OF EMBODIMENTS

A ferritic stainless steel welding wire according to an embodiment of the present invention includes C, Si, Mn, P, S, Cu, Ni, Cr, Mo, Ti, Nb, Al, O, and N, with the balance being Fe and unavoidable impurities. Mg is further included.

Reasons for limiting each chemical component in the ferritic stainless steel welding wire of the present embodiment will be described in detail below. Note that in the following description, “%” means “mass %” unless otherwise specified.

C: ≤0.050%

C is an element added to ensure strength of a weld metal portion. C is also an austenite forming element, and has an effect of promoting formation of an austenite phase. However, excessive addition thereof tends to cause weld cracks due to formation of martensite. Precipitation of Cr carbides forms a Cr-deficient layer at grain boundaries, resulting in deterioration of a corrosion resistance. Therefore, in the present embodiment, an upper limit of C content is set to 0.050%. A preferable content of C is 0.010% to 0.030%.

Si: ≤1.00%

Si is an element that acts as a deoxidizing agent and is also effective in preventing weld cracks. However, excessive addition thereof causes deterioration in toughness and decrease in mechanical strength, so that an upper limit of Si content is set to 1.00%. A preferable content of Si is 0.30% or less. A more preferable content thereof is 0.17% or less.

Mn: 2.50% to 5.00%

Mn is an austenite forming element. In the present embodiment, 2.50% or more of Mn is included in order to promote the formation of the austenite phase. However, excessive addition thereof produces sulfides and deteriorates the toughness, so that an upper limit of Mn content is set to 5.00%. A preferable content of Mn is 3.50% to 4.50%.

P: ≤0.040%, S: ≤0.010%

Excessive P and S tend to cause weld cracks, and toughness of the weld metal portion is deteriorated. Therefore, P content needs to be 0.040% or less, and S content needs to be 0.010% or less.

Cu: ≤0.50%

Cu is an element that improves tensile strength and corrosion resistance. However, excessive addition thereof causes a decrease in toughness and ductility, so that an upper limit of Cu content is set to 0.50%. A preferable content of Cu is 0.10% to 0.40%.

Ni: 0.01% to 1.00%

Ni is an austenite forming element, and has an effect of promoting the formation of the austenite phase together with Mn and the like. Ni also improves the ductility and toughness. However, excessive addition thereof lowers weld crack resistance, so that a Ni content in the present embodiment is set to 0.01% to 1.00%. A preferable content of Ni is 0.30% to 0.80%.

Cr: 12.0% to 20.0%

Cr increases the strength of the weld metal and forms a dense oxide film on a surface of the weld metal to improve oxidation resistance and corrosion resistance. In order to obtain such effects, Cr is included in an amount of 12.0% or more in the present embodiment. However, excessive addition thereof saturates the effect of corrosion resistance and has a large demerit of an increase in material cost. Moreover, hardening due to excessive addition of Cr deteriorates manufacturability. Therefore, in the present embodiment, an upper limit of Cr content is set to 20.0%. A preferable content of Cr is 15.0% to 19.0%.

Mo: ≤0.50%

Mo is an element effective for improving high-temperature strength and corrosion resistance. However, when Mo is added excessively, corresponding characteristics are saturated and material cost increases, so that an upper limit of Mo content is set to 0.50%. A preferable content of Mo is 0.10% to 0.40%.

Ti: 0.20% to 2.00%

Nitrides of Ti are finely dispersed in molten metal as inclusions during welding, and function as nuclei during ferrite formation, and Ti has an effect of refining crystal grains of the weld metal. Since carbonitrides of Ti are preferentially formed over carbonitrides of Cr, sensitization can be reduced. However, excessive addition thereof impairs weldability, oxides thereof become slag, and appearance of bead deteriorate. Therefore, in the present embodiment, a Ti content is set to 0.20% to 2.00%. A preferable content of Ti is 0.40% to 0.70%.

Nb: 0.10% to 0.80%

Nb can reduce sensitization in the same way as Ti since carbonitrides of Nb are preferentially formed over carbonitrides of Cr. A pinning effect of Nb carbide at grain boundaries prevents coarsening of crystal grains and improves the oxidation resistance and high-temperature strength. However, excessive addition thereof causes deterioration of weld crack resistance. Therefore, in the present embodiment, a Nb content is set to 0.10% to 0.80%. A preferable content of Nb is 0.30% to 0.70%.

Al: 0.020% to 0.200%

Oxides of Al are formed to promote crystallization of TiN. Al also acts as a deoxidizing agent and has the same effect of improving the oxidation resistance as Nb. However, since excessive addition thereof causes a decrease in toughness and an increase in spatter, an Al content is set to 0.020% to 0.200% in the present embodiment. A preferable content of Al is 0.030% to 0.100%.

Mg: ≤0.020% (including zero)

Since Mg forms spinel (MgAl₂O₄) and has an effect of promoting the crystallization of TiN, Mg can be included as necessary. However, excessive addition thereof deteriorates weldability, so that an upper limit of the Mg content is set to 0.020%. The Mg content may be zero.

O: ≤0.020%

O forms oxides such as SiO₂ and Al₂O₃, and the resulting oxide lowers the toughness. Therefore, a content of O needs to be 0.020% or less.

N: 0.001% to 0.050%

N forms TiN that functions as nuclei during the formation of ferrite. N is also an austenite forming element and promotes the formation of the austenite phase. However, excessive addition thereof forms Cr nitrides and lowers the corrosion resistance. Therefore, in the present embodiment, a content of N is set to 0.001% to 0.050%. A preferable content of N is 0.020% to 0.040%.

A Ni equivalent represented by Equation (1): 1.0 to 3.0

Ni equivalent=[Ni]+0.5×[Mn]+30×[C]+30×([N]−0.06) Equation (1).

The Ni equivalent is an index related to an amount of the austenite phase generated in the process of solidifying and cooling the weld metal. By adjusting the contents of Ni, Mn, C, and N so that the Ni equivalent is 1.0 or more, a part of a 6 ferrite phase is once transformed into austenite. In the present embodiment, by utilizing this phase transformation, it is possible to obtain an effect of refining the crystal grains.

However, when the Ni equivalent is excessively high, an austenite single-phase structure is generated, and the refining effect cannot be obtained, and therefore in the present embodiment, the Ni equivalent is set within a range of 1.0 to 3.0. A preferable range of the Ni equivalent is 1.5 to 2.5.

T value represented by Equation (2): 12.0 or more

T value=([Ti]+[Nb])/([C]+[N]) Equation (2)

In ferritic stainless steel, Cr is consumed by formation of carbides and nitrides of Cr, and a so-called Cr-deficient layer is formed, resulting in deterioration of the corrosion resistance. In order to prevent the formation of the Cr-deficient layer, it is effective to reduce C and N, and to add carbonitride forming elements (Ti and Nb) that form carbides and nitrides preferentially over Cr. According to research by the present inventors, in the case where the T value represented by ([Ti]+[Nb])/([C]+[N]) is less than 12.0, the effect of preventing the formation of the Cr-deficient layer is insufficient, so that in the present embodiment, components are adjusted to have a T value of 12.0 or more. A more preferable T value is 14.0 or more.

The welding wire of the present embodiment having the above chemical composition has a main phase of ferrite single-phase structure. A diameter and a length of the welding wire are not particularly limited, and values can be selected according to purposes. The welding wire of the present embodiment may be a solid wire consisting of ferritic stainless steel, or a flux-cored wire containing flux.

In a welded part assembled by welding members made of ferritic stainless steel using the present welding wire, a grain size number in the weld metal portion can be 3 or more.

### Examples

Next, examples of the present invention will be described below. Here, test pieces (welded parts) were prepared by welding using welding wires each having chemical compositions of Examples and Comparative Examples shown in Table 1 below, and grain size measurement, corrosion resistance test, cracking resistance test, and bending test for weld metal were performed.

TABLE 1

| | | Chemical compositions (mass %) (balance: Fe) | | | | | | | | |
|---|---|---|---|---|---|---|---|---|---|---|
| | | C | Si | Mn | P | S | Cr | Ti | O | N |
| Example | 1 | 0.023 | 0.20 | 3.99 | 0.022 | 0.004 | 16.05 | 0.38 | 0.009 | 0.041 |
| | 2 | 0.026 | 0.35 | 2.51 | 0.013 | 0.009 | 16.54 | 0.53 | 0.012 | 0.036 |
| | 3 | 0.043 | 0.26 | 3.53 | 0.031 | 0.003 | 17.34 | 0.22 | 0.004 | 0.017 |
| | 4 | 0.015 | 0.38 | 2.82 | 0.038 | 0.005 | 17.57 | 0.38 | 0.008 | 0.047 |
| | 5 | 0.023 | 0.25 | 4.63 | 0.027 | 0.006 | 15.93 | 0.74 | 0.003 | 0.032 |
| | 6 | 0.012 | 0.23 | 3.24 | 0.023 | 0.003 | 18.46 | 0.36 | 0.011 | 0.049 |
| | 7 | 0.018 | 0.16 | 3.74 | 0.016 | 0.007 | 17.98 | 0.45 | 0.005 | 0.038 |
| | 8 | 0.016 | 0.22 | 3.29 | 0.036 | 0.004 | 16.45 | 0.49 | 0.006 | 0.029 |
| | 9 | 0.041 | 0.62 | 4.27 | 0.023 | 0.007 | 16.29 | 1.36 | 0.007 | 0.003 |
| | 10 | 0.032 | 0.93 | 3.84 | 0.015 | 0.007 | 15.83 | 1.82 | 0.011 | 0.006 |
| | 11 | 0.019 | 0.49 | 4.13 | 0.018 | 0.006 | 16.73 | 0.88 | 0.005 | 0.013 |
| | 12 | 0.042 | 0.43 | 3.45 | 0.023 | 0.006 | 16.23 | 0.31 | 0.006 | 0.045 |
| Comparative | 1 | 0.062 | 0.22 | 3.42 | 0.015 | 0.021 | 21.24 | 0.52 | 0.003 | 0.032 |
| Example | 2 | 0.017 | 0.28 | 3.43 | 0.019 | 0.003 | 17.52 | 0.36 | 0.008 | 0.117 |
| | 3 | 0.039 | 0.25 | 4.52 | 0.036 | 0.007 | 18.72 | 0.13 | 0.006 | 0.042 |
| | 4 | 0.023 | 0.31 | 2.35 | 0.051 | 0.005 | 11.78 | 2.83 | 0.014 | 0.018 |
| | 5 | 0.028 | 0.27 | 5.13 | 0.026 | 0.008 | 16.83 | 0.62 | 0.007 | 0.027 |
| | 6 | 0.019 | 0.35 | 0.92 | 0.017 | 0.004 | 16.41 | 0.34 | 0.031 | 0.006 |
| | 7 | 0.021 | 1.42 | 3.18 | 0.026 | 0.004 | 16.25 | 0.38 | 0.006 | 0.045 |
| | 8 | 0.022 | 0.36 | 2.63 | 0.024 | 0.005 | 16.74 | 0.42 | 0.011 | 0.021 |

| | | Chemical compositions (mass %) (balance: Fe) | | | | | | Ni | T |
|---|---|---|---|---|---|---|---|---|---|
| | | Nb | Al | Mo | Cu | Ni | Mg | equivalent | value |
| Example | 1 | 0.40 | 0.046 | 0.03 | 0.25 | 0.24 | — | 2.4 | 12.2 |
| | 2 | 0.36 | 0.023 | 0.14 | 0.23 | 0.62 | — | 1.9 | 14.4 |
| | 3 | 0.75 | 0.032 | 0.32 | 0.46 | 0.63 | — | 2.4 | 16.2 |
| | 4 | 0.45 | 0.063 | 0.18 | 0.13 | 0.46 | — | 1.9 | 13.4 |
| | 5 | 0.42 | 0.188 | 0.01 | 0.23 | 0.23 | — | 2.4 | 21.1 |
| | 6 | 0.63 | 0.136 | 0.32 | 0.03 | 0.26 | — | 1.9 | 16.2 |
| | 7 | 0.52 | 0.095 | 0.14 | 0.32 | 0.25 | — | 2.0 | 17.3 |
| | 8 | 0.42 | 0.054 | 0.09 | 0.34 | 0.35 | 0.010 | 1.6 | 20.2 |
| | 9 | 0.34 | 0.034 | 0.47 | 0.13 | 0.07 | — | 1.7 | 38.6 |
| | 10 | 0.14 | 0.046 | 0.23 | 0.32 | 0.15 | — | 1.4 | 51.6 |
| | 11 | 0.23 | 0.061 | 0.11 | 0.27 | 0.03 | — | 1.3 | 34.7 |
| | 12 | 0.24 | 0.042 | 0.05 | 0.21 | 0.32 | — | 2.9 | 6.3 |
| Comparative | 1 | 0.43 | 0.074 | 0.33 | 0.17 | 0.26 | — | 3.0 | 10.1 |
| Example | 2 | 0.47 | 0.310 | 0.49 | 1.73 | 0.25 | — | 4.2 | 6.2 |
| | 3 | 0.38 | 0.011 | 0.16 | 0.11 | 0.53 | — | 3.4 | 6.3 |
| | 4 | 0.44 | 0.032 | 0.27 | 0.47 | 0.24 | — | 0.9 | 79.8 |
| | 5 | 0.03 | 0.057 | 0.29 | 0.16 | 0.27 | — | 2.7 | 11.8 |
| | 6 | 0.58 | 0.024 | 2.30 | 0.18 | 0.24 | — | −0.4 | 36.8 |
| | 7 | 1.22 | 0.037 | 0.31 | 0.26 | 2.32 | — | 4.1 | 24.2 |
| | 8 | 0.41 | 0.043 | 0.23 | 0.23 | 0.11 | — | 0.9 | 19.3 |

1. Preparation of Test Pieces for Grain Size Measurement and Corrosion Resistance Test

An alloy having the chemical composition shown in Table 1 was melted, and an obtained ingot was subjected to hot working and cold working, and a welding wire having a diameter of 1.2 mm was prepared.

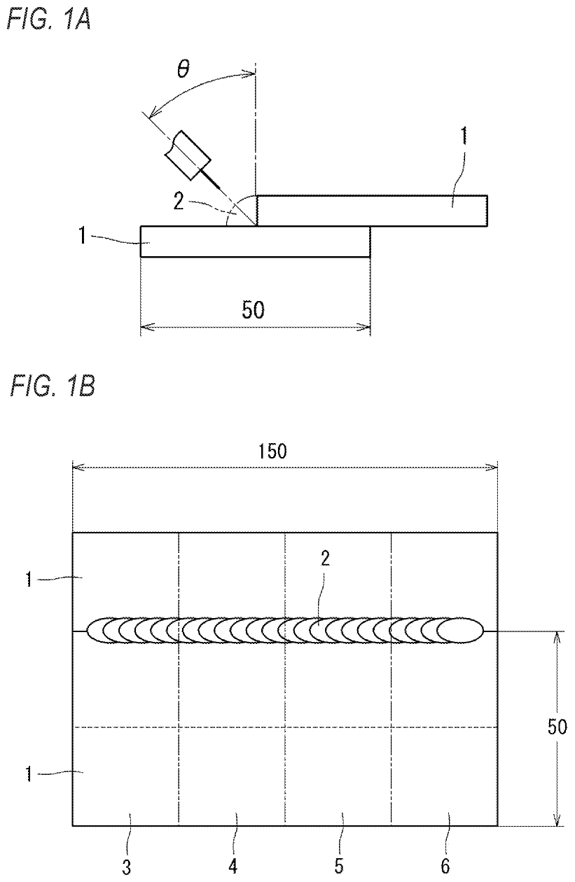

Next, as shown in FIG. 1A, two SUS430 (JIS-G-4305: 2012) stainless steel plates 1, 1 each having a thickness of 1.5 mm, a length of 150 mm, and a width of 50 mm were arranged so that ends thereof in a width direction overlap each other by 25 mm, and gas-shielded arc welding was performed across the two stainless steel plates 1, 1 so as to form a bead 2. Shielding gas of Ar+3.5% of O₂ flowed at a flow rate of 15 L/min under a current of 130 A and a voltage of 21 V, and welding was performed at a welding speed of 70 cm/min with a torch angle θ of 45°. Then, as indicated by two-dot chain lines in FIG. 11B, the welded stainless steel plate was divided into quarters to form cut pieces 3 to 6, and the two central test pieces 4 and 5 were used for the grain size measurement and corrosion resistance test.

2. Grain Size Measurement

The grain size of the weld metal was determined in accordance with ferrite grain size measurement test method described in JIS-G-0552:1998. Results are shown in Table 2. A target grain size number is 3 or more.

3. Corrosion Resistance Test

The corrosion resistance test was conducted in accordance with an oxalic acid etching test method for stainless steel described in JIS-G-0571:2003. The weld metal portion (bead 2) of the cut piece 5 (see FIG. 1B) was immersed in a 10% oxalic acid solution and energized at a constant current density to determine the corrosion resistance. Results are shown in Table 2. Judgment criteria were as follows.
A: a stepped structure was observed.
B: a mixed structure was observed.
C: a groove structure was observed.

Here, the stepped structure is a stepped structure without grooves at grain boundaries, which appears since a corrosion rate differs for each crystallographic orientation. The mixed structure is a structure with grooves at partial grain boundaries (but no grains are completely surrounded by grooves). The groove structure is a structure in which one or more grains are completely surrounded by grooves.

4. Cracking Resistance Test

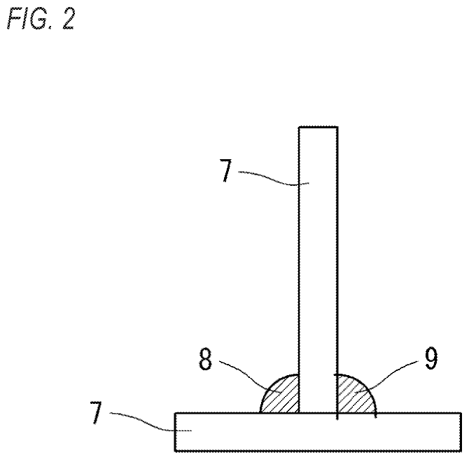

The cracking resistance test was conducted in accordance with a T-type weld crack test describe in JIS-Z-3153:1993. As shown in FIG. 2, two SUS430 stainless steel plates 7, 7 each having a thickness of 15 mm, a length of 150 mm, and a width of 50 mm are arranged in a T shape, and gas-shielded arc welding was performed across the two stainless steel plates 7, 7 to form a test bead 8 and a restraining bead 9 as follows.

First, the shielding gas of Ar+3.5% of 02 flowed at a flow rate of 15 L/min under a current of 210 A and a voltage of 23 V, and the restraining bead 9 was formed at a welding speed of 40 cm/min. Next, the shielding gas of Ar+3.5% of O₂ flowed at a flow rate of 15 L/min under a current of 210 A and a voltage of 23 V, and the test bead 8 was formed at a welding speed of 70 cm/min. Then, a surface crack rate represented by [(crack length/bead length)×100] of the test bead 8 excluding a crater portion was obtained for judgement. Results are shown in Table 2. Judgment criteria were as follows.
A: the crack rate is 0%.
B: the crack rate is more than 0% and less than 20%.
C: the crack rate is 200 or more.

5. Bending Test

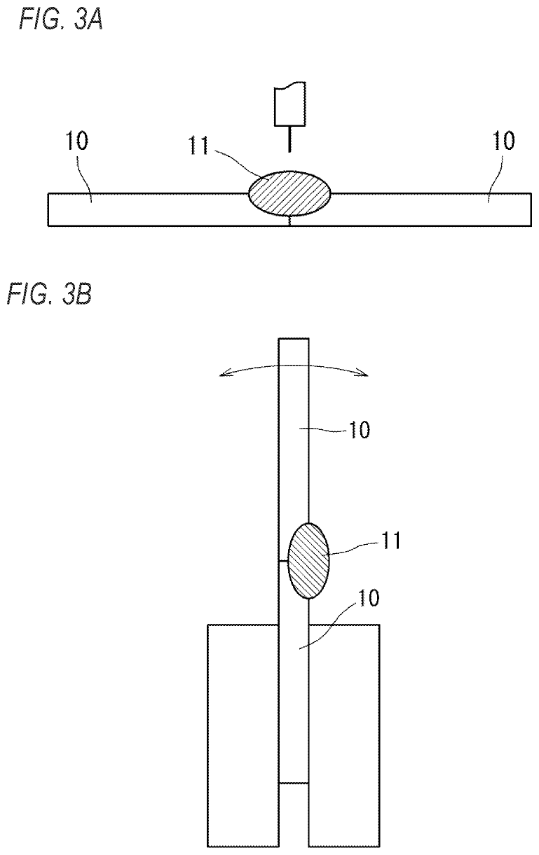

In the bending test, as shown in FIG. 3A, two SUS430 stainless steel plates 10, 10 each having a thickness of 1.5 mm, a length of 150 mm, and a width of 50 mm were arranged with a gap of 0 mm, and gas-shielded arc welding was performed across the two stainless steel plates 10, 10 so as to form a bead 11. The shielding gas of Ar+3.5% of O₂ flowed at a flow rate of 15 L/min under a current of 130 A and a voltage of 21 V, and the welding was formed at a welding speed of 70 cm/min. Then, one stainless steel plate 10 was restrained as shown in FIG. 31B, and the other stainless plate 10 was repeatedly bent within an angle of 60 degrees to count how many times of bending the bead 11 can withstand. Results are shown in Table 2.

TABLE 2

| | | Grain size | Corrosion | Cracking | Bending |
|---|---|---|---|---|---|
| | | (grain size | resistance | resistance | test |
| | | number) | test | test | (times) |
| Example | 1 | 4.5 | A | A | 7 |
| | 2 | 3 | A | A | 6 |
| | 3 | 3 | A | A | 7 |
| | 4 | 4 | A | A | 6 |
| | 5 | 5 | A | A | 8 |
| | 6 | 4.5 | A | A | 6 |
| | 7 | 4 | A | A | 7 |
| | 8 | 4.5 | A | A | 6 |
| | 9 | 5 | A | A | 7 |
| | 10 | 5 | A | A | 7 |
| | 11 | 4.5 | A | A | 6 |
| | 12 | 3 | C | A | 5 |
| Comparative | 1 | 3 | C | C | 2 |
| Example | 2 | 1.5 | C | A | 1 |
| | 3 | 1 | C | A | 4 |
| | 4 | 2 | C | C | 3 |
| | 5 | 3 | B | A | 2 |
| | 6 | 1 | A | A | 1 |
| | 7 | 2 | A | B | 2 |
| | 8 | 2 | A | A | 2 |

The results in Tables 1 and 2 reveal the following.

Comparative Example 1 is an example in which C, S, and Cr were added in excess of the ranges specified in the present embodiment, and although the weld metal is refined, the evaluations of the corrosion resistance and the cracking resistance are “C”, and the times in the evaluation of the bending test is also small.

In Comparative Example 2, the Ni equivalent exceeded the upper limit specified in the present embodiment, and the weld metal has a grain size number of 1.5 and is not refined. N, Al, and Cu were also added excessively, and the evaluation of the corrosion resistance is “C”, and the times in the evaluation of the bending test is also small.

In Comparative Example 3, contents of Ti and Al, which contribute to refinement, were below the lower limits specified in the present embodiment, and the Ni equivalent was also out of the range specified in the present embodiment, and the weld metal has a grain size number of 1 and is not refined. Since the amount of Ti was small, the evaluation of the corrosion resistance is “C”.

In Comparative Example 4, the content of Mn and the Ni equivalent were below the lower limits specified in the present embodiment, so that the weld metal has a grain size number of 2 and is not refined. In Comparative Example 4, P and Ti were added in excess of the ranges specified in the present embodiment, and the evaluation of the cracking resistance is “C”. The content of Cr was also below the lower limit and the evaluation of the corrosion resistance is “C”.

In Comparative Example 5, the content of Mn exceeded the upper limit specified in the present embodiment, and the times in the evaluation of the bending test is small. Since the content of Nb was also small, the evaluation of the corrosion resistance is “B”.

In Comparative Example 6, the content of Mn and the Ni equivalent were below the lower limits specified in the present embodiment, so that the weld metal has a grain size number of 1 and is not refined. The contents of Mo and O exceeded the upper limits specified in the present embodiment, and the times in the evaluation of the bending test is small.

In Comparative Example 7, the Ni equivalent exceeded the upper limit specified in the present embodiment, and the weld metal has a grain size number of 2 and is not refined. Ni, Nb, and Si were excessively added exceeding the upper limits, and the evaluation of the cracking resistance is bad and the time in the valuation of bending test is also small.

In Comparative Example 8, the Ni equivalent was below the lower limit specified in the present embodiment, so that the weld metal has a grain size number of 2 and is not refined. The time in the evaluation of the bending test is also small.

According to the results of these Comparative Examples, in the case where the Ni equivalent exceeds the upper limit of the range specified in the present embodiment, or in the case where the Ni equivalent falls below the lower limit, it can be recognized that the targeted refinement for the weld metal microstructure is not achieved.

In Comparative Examples 2, 3, and 5, in which the T value did not reach the value specified in the present embodiment, the evaluation of the corrosion resistance is bad even though the Cr content is appropriate.

On the other hand, Examples 1 to 12, in which the chemical composition (including the Ni equivalent) of the welding wire was within the range specified in the present embodiment, are good in both the grain size and the cracking resistance test. In other words, it can be recognized that the welding wires of Examples 1 to 12 are effective in refining the microstructure of the weld metal and preventing the occurrence of cracks in the weld metal portion.

Here, Example 12 is an example in which an addition amount of each element was within the range specified in the present embodiment, but the T value was low. The evaluations of the grain size and the cracking resistance are good, but the evaluation of the corrosion resistance is “C”.

On the other hand, Examples 1 to 11, in which the T value also satisfied the stipulations of the present embodiment, are also evaluated as good in the corrosion resistance.

Although the embodiment and Examples of the present invention have been described in detail above, the present invention is not limited to these, and various changes can be made without departing from the scope of the invention.

The present application is based on Japanese Patent Applications No. 2022-094541 filed on Jun. 10, 2022 and No. 2023-025406 filed on Feb. 21, 2023, and the contents thereof are incorporated herein by reference.

What is claimed is:

1. A ferritic stainless steel welding wire, comprising, in terms of mass %:
C: ≤0.050%;
Si: ≤1.00%;
Mn: 2.50% to 5.00%;
P: ≤0.040%;
S: ≤0.010%;
Cu: ≤0.50%;
Ni: 0.01% to 1.00%;
Cr: 12.0% to 20.0%;
Mo: ≤0.50%;
Ti: 0.20% to 2.00%;
Nb: 0.10% to 0.80%;
Al: 0.020% to 0.200%;
Mg: ≤0.020%;
O: ≤0.020%; and
N: 0.001% to 0.050%,
with the balance being Fe and unavoidable impurities,
and having a Ni equivalent represented by Equation (1) of 1.0 to 3.0,
Ni equivalent=[Ni]+0.5×[Mn]+30×[C]+30×([N]−0.06) Equation (1),
in Equation (1), [X] represents a content (mass %) of an element X.

2. The ferritic stainless steel welding wire according to claim 1, having a T value represented by Equation (2) of 12.0 or more,
T value=([Ti]+[Nb])/([C]+[N]) Equation (2)
in Equation (2), [X] represents a content (mass %) of an element X.

3. A welded part, comprising:
a weld metal portion formed using the ferritic stainless steel welding wire according to claim 1, wherein
the weld metal portion has a grain size number of 3 or more.

4. A welded part, comprising:
a weld metal portion formed using the ferritic stainless steel welding wire according to claim 2, wherein
the weld metal portion has a grain size number of 3 or more.
